(19) United States
(12) Patent Application Publication
(10) Pub. No.: US 2014/0239886 A1
(43) Pub. Date: Aug. 28, 2014

(54) Automatic Protocol (AP) for USB Charger System

(71) Applicant: Delta Electronics (Thailand), Samutprak (TH)

(72) Inventors: Pornchai Lalitnuntikul, Samutprakarn (TH); Jui-Ching Huang, Samutprakam (TH); Huan-Yu Tseng, Samutprakarn (TH)

(21) Appl. No.: 14/347,945

(22) PCT Filed: Oct. 1, 2012
(86) PCT No.: PCT/IB2012/002609

§ 371 Date: Mar. 27, 2014

Related U.S. Application Data
(60) Provisional application No. 61/540,974, filed on Sep. 29, 2011.

(51) Int. Cl. H02J 7/00

(52) U.S. Cl. CPC H02J 7/0052; H02J 2007/0062
USPC 320/107

(57) ABSTRACT

An automatic protocol (AP) for a USB charger is provided, that enables recognition of the voltage pin (D−) and pin (D+) needs of the device being charged, and controls the voltage level to charge the device, based on the recognized voltage needs.

### RELATED APPLICATION/CLAIM OF PRIORITY

This application and invention are related to and claim priority from provisional application serial number, filed Sep. 29, 2011, and entitled Automatic protocol (AP) for USB charger system, which provisional application is incorporated by reference herein.

### INTRODUCTION

The present invention relates to an automatic protocol (AP) for a USB charger system, that is designed to recognize the voltage needs of the device being charged, and controls the voltage level of the charger system to charge the device, based on the recognized voltage needs of the device. The present invention is particularly useful with portable devices.

### BACKGROUND

Micro USB (Micro universal serial bus) connections are becoming increasingly common for portable devices. Some portable device manufacturers use voltage configuration on USB pin 2(D−) and pin 3(D+) to synchronize the signal between the USB Charger and portable device in order to provide a charging mode for the USB device. Each manufacturer device needs difference voltage on Pin2 (D−) and Pin3 (D+). Most USB chargers are specifically designed to fix the charging voltage to match with a specific portable device. The problem is that a USB charger may use a micro USB standard port, but may not be able to charge other devices due to difference voltage on D− and D+ configuration.

The USB standard is widespread in the industry, which has made it a standard also for small peripheral equipment charging. As part of the original standard, the device that is attached to a host would normally be provided with 100 mA of current. Thus the host would have a power budget. Incorporated into the standard was a digital protocol for a device to request more current from the host (a maximum of 500 mA). The host would normally evaluate if it had the available resources to answer this request. There arose a need to have independent chargers without the “smart” host abilities since having a full USB digital protocol requires a large microcontroller which is cost prohibitive on simple chargers. So a simple standard was adapted so that a simple charger could communicate to the host easily without having a complicated microcontroller on board. This standard involves shorting the D+ and D− together so a device being charged gets an echo from D− when it moves D+ and vice versa.

The D+ to D− short standard was adapted for the majority of devices. But it is not the only standard. Some manufacturers incorporated their own standards either because of the delay of the USB standard or because they desired other features. One feature that was desired was to communicate the amount of charging ability of the charger. Since by that time the maximum charging current moved from 500 mA to 1 Amp and even up to 2 Amps. One company decided to incorporate a divider protocol in which the dividers on the D+ and D− signals would indicate the charging ability. Another manufacturer just ties one signal D+ high and the other low while another does the opposite (D+ low). So, for a charger to be universal it would have to incorporate all these standards which became very difficult. So this places a burden on the consumer, who would have to buy a specific adapter that included a resistor network that would include the particular configuration protocol for their device. This is wasteful in the sense that the same connector would have to be bought several times for different devices just because the resistor network was different.

### SUMMARY OF THE PRESENT INVENTION

The present invention relates to a new and useful automatic protocol (AP) for a USB charger, which comprises a circuit that enables recognition of the voltage pin (D−) and pin (D+) needs of the device being charged, and controls the voltage level to charge the device, based on the recognized voltage needs.

Thus, one purpose of the present invention is to provide a changing resistor network that will adapt itself to a particular device it is charging. This device could again be incorporated in the charger and frees the consumer from figuring out which connector to buy (if any).

In a preferred embodiment, the circuit is configured to charge any of a plurality of different portable devices, each of which has different voltage needs. The circuit is configured to modify the voltage at the data lines of a USB port to meet needs of any of the plurality of portable devices.

Additional features of the present invention will be apparent from the following detailed description and the accompanying drawings

### BRIEF DESCRIPTION OF THE DRAWINGS

FIGS. 1 and 2 are a schematic illustrations of an automatic protocol (AP) for a USB charger system, according to the present invention;

FIGS. 3-5 are circuit diagrams of portions of an automatic protocol (AP) for a USB charger system, according to the present invention; and

FIGS. 6A-6F are circuit diagrams of certain components of an automatic protocol (AP) for a USB charger system, according to the present invention.

### DETAILED DESCRIPTION

As described above, the present invention relates to a new and useful automatic protocol (AP) for a USB charger, which comprises a circuit that enables recognition of the voltage pin (D−) and pin (D+) needs of the device being charged, and controls the voltage level to charge the device, based on the recognized voltage needs. In a preferred embodiment, the circuit is configured to charge any of a plurality of different portable devices, each of which has different voltage needs. The circuit is configured to modify the voltage at the data lines of a USB port to meet needs of any of the plurality of portable devices. The present invention is described herein in connection with such a circuit, and from that description the manner in which the principles of the present invention can be applied to various USB charger circuits will be apparent to those in the art.

As also described above, Micro USB (Micro universal serial bus) connections are becoming increasingly common for portable devices. Some portable device manufacturers use voltage configuration on USB pin 2(D−) and pin 3(D+) to synchronize the signal between the USB Charger and portable device in order to provide a charging mode for the USB device. Each manufacturer device needs difference voltage on Pin2 (D−) and Pin3 (D+). Most USB chargers are specifically designed to fix the charging voltage to match with a specific portable device. The problem is that a USB charger may use a micro USB standard port, but may not be able to charge other devices due to difference voltage on D− and D+ configuration.

The USB standard is widespread in the industry, which has made it a standard also for small peripheral equipment charging. As part of the original standard, the device that is attached to a host would normally be provided with 100 mA of current. Thus the host would have a power budget. Incorporated into the standard was a digital protocol for a device to request more current from the host (a maximum of 500 mA). The host would normally evaluate if it had the available resources to answer this request. There arose a need to have independent chargers without the “smart” host abilities since having a full USB digital protocol requires a large microcontroller which is cost prohibitive on simple chargers. So a simple standard was adapted so that a simple charger could communicate to the host easily without having a complicated microcontroller on board. This standard involves shorting the D+ and D− together so a device being charged gets an echo from D− when it moves D+ and vice versa.

The D+ to D− short standard was adapted for the majority of devices. But it is not the only standard. Some manufacturers incorporated their own standards either because of the delay of the USB standard or because they desired other features. One feature that was desired was to communicate the amount of charging ability of the charger. Since by that time the maximum charring current moved from 500 mA to 1 Amp and even up to 2 Amps. One company decided to incorporate a divider protocol in which the dividers on the D+ and D− signals would indicate the charging ability. Another manufacturer just ties one signal D+ high and the other low while another does the opposite (D+ low). So, for a charger to be universal it would have to incorporate all these standards which became very difficult. So this places a burden on the consumer, who would have to buy a specific adapter that included a resistor network that would include the particular configuration protocol for their device. This is wasteful in the sense that the same connector would have to be bought several times for different devices just because the resistor network was different.

The present invention relates to a new and useful automatic protocol (AP) for a USB charger, which comprises a circuit that enables recognition of the voltage pin (D−) and pin (D+) needs of the device being charged, and controls the voltage level to charge the device, based on the recognized voltage needs.

Thus, one purpose of the present invention is to provide a changing resistor network that will adapt itself to a particular device it is charging. This device could again be incorporated in the charger and frees the consumer from figuring out which connector to buy (if any).

In a preferred embodiment, the circuit is configured to charge any of a plurality of different portable devices, each of which has different voltage needs. The circuit is configured to modify the voltage at the data lines of a USB port to meet needs of any of the plurality of portable devices.

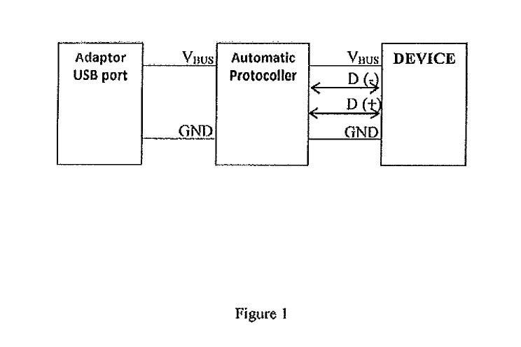

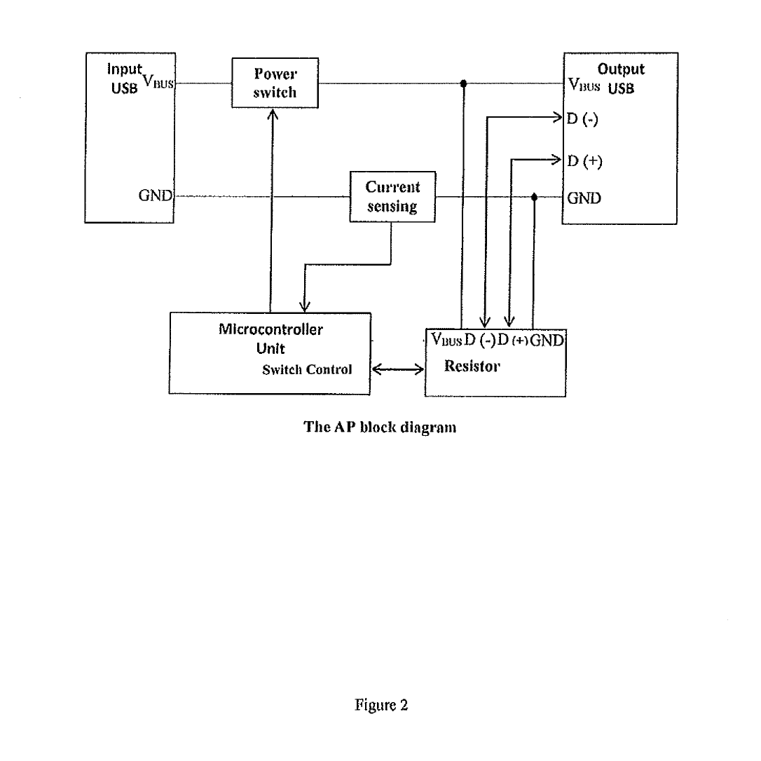

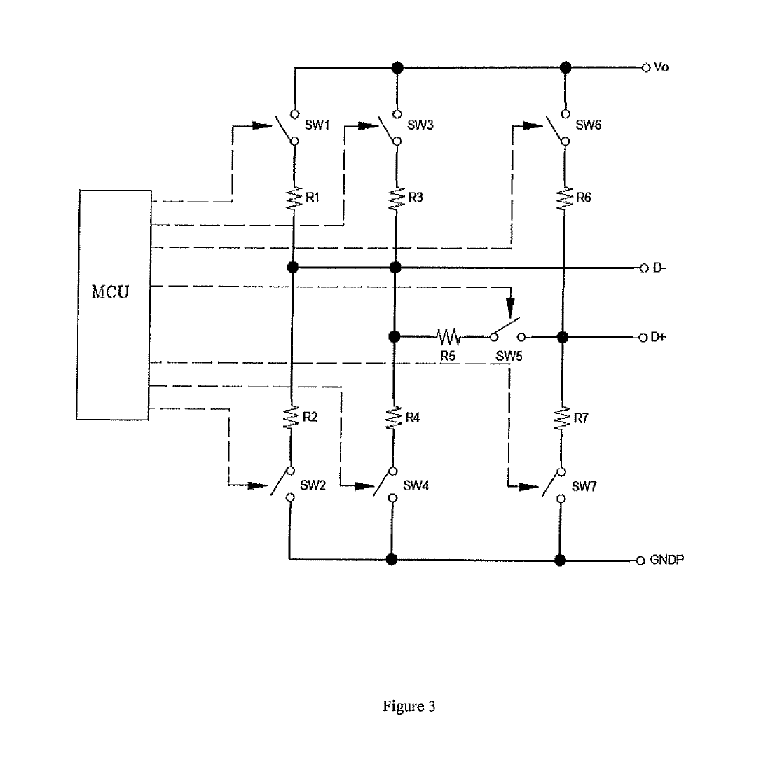

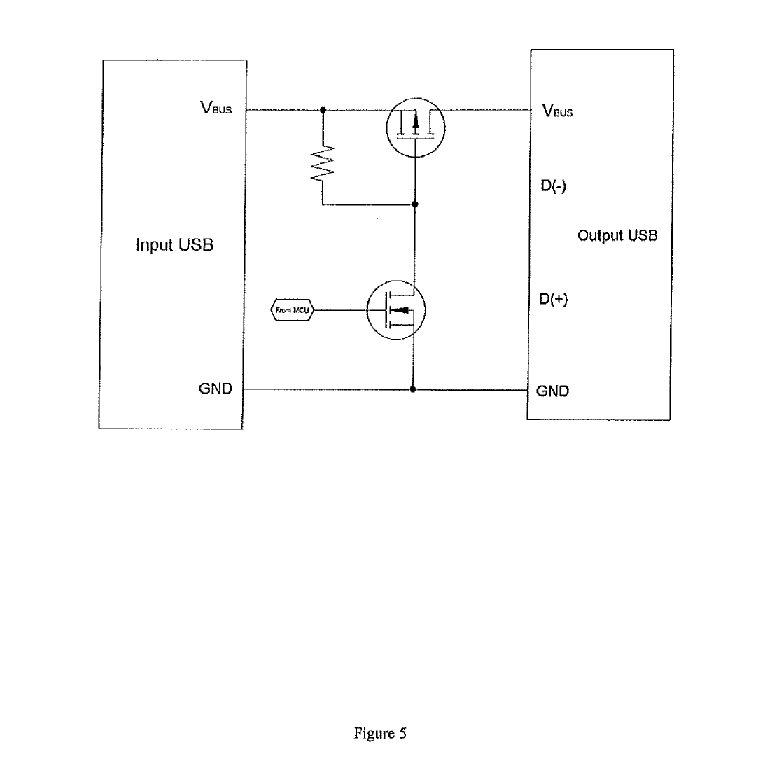

The automatic protocol (AP) circuit for a USB charger system, according to the present invention, can be seen in the schematics of FIGS. 1 and 2, and the circuit diagrams of FIGS. 3-5 and 6A-6F. The circuit diagrams of FIGS. 3-5 and 6A-6F provide one example of the manner in which the principles of the present invention can be implemented, and from that example, and the remaining description herein, it will be clear to those in the art how to implement the principles of the present invention in various ways.

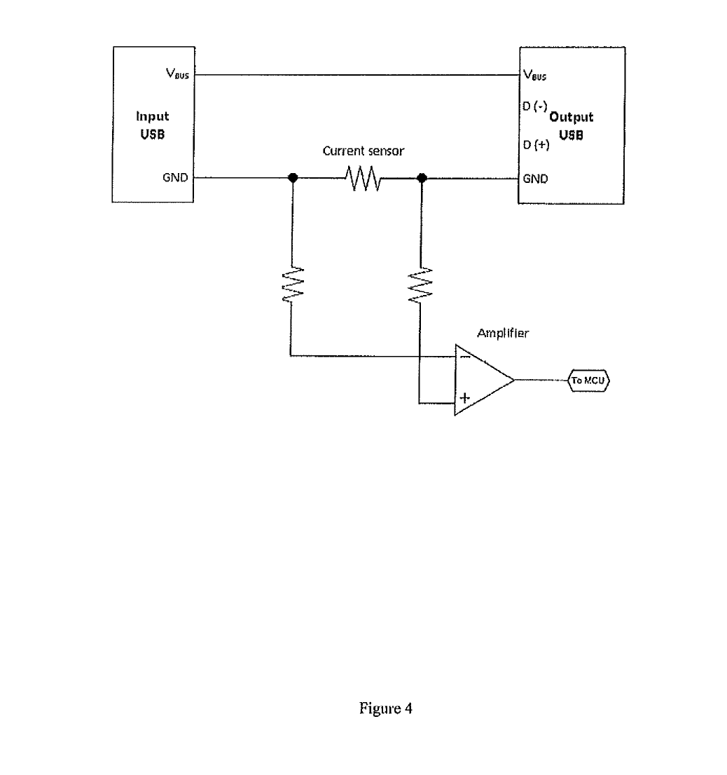

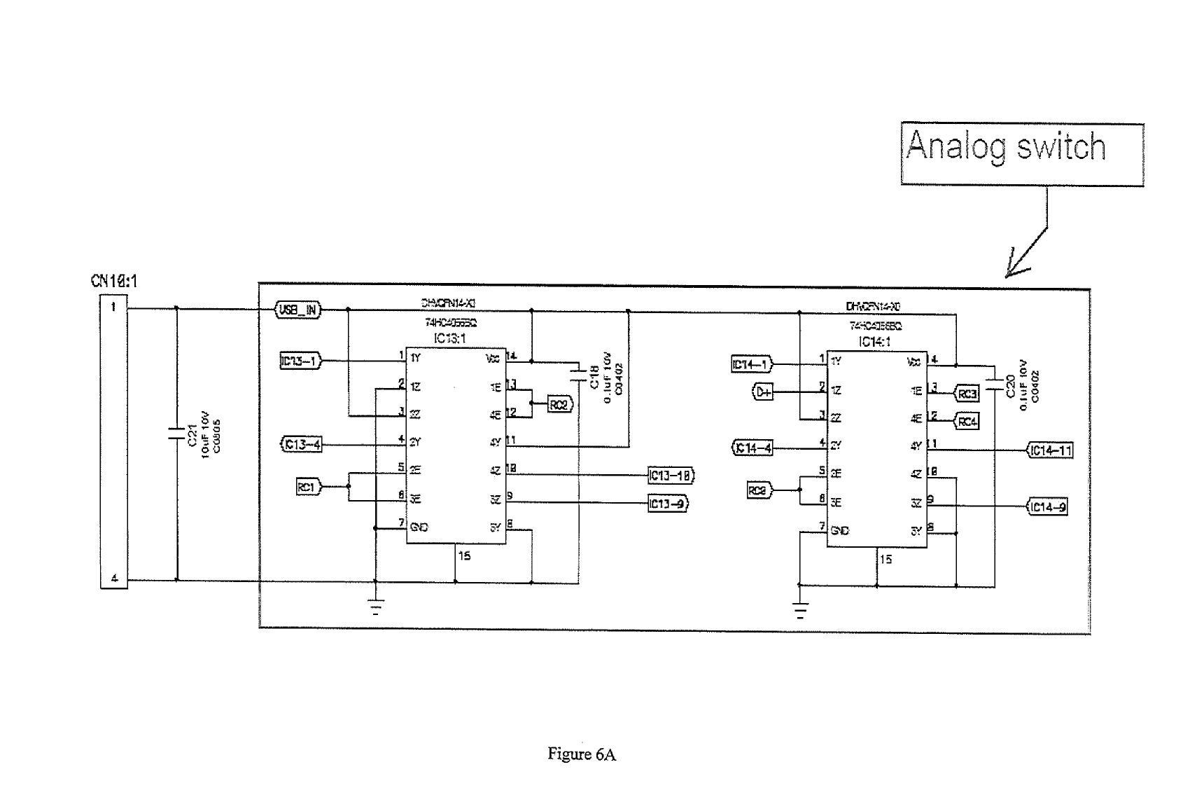

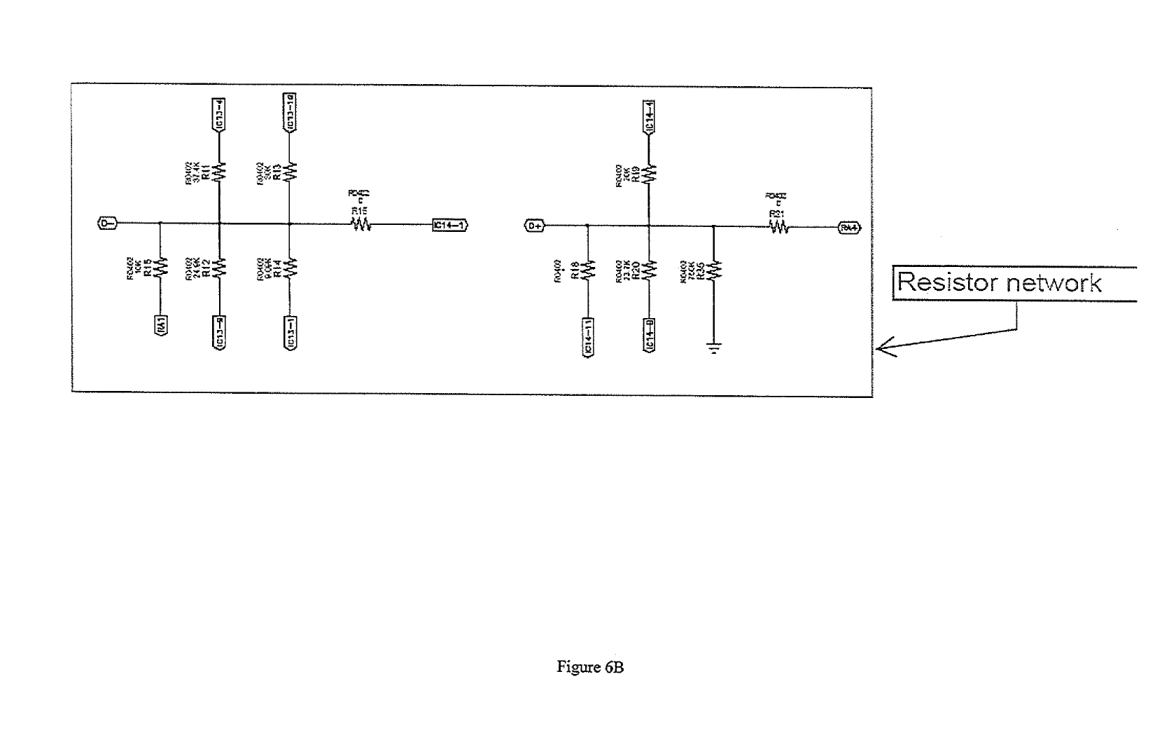

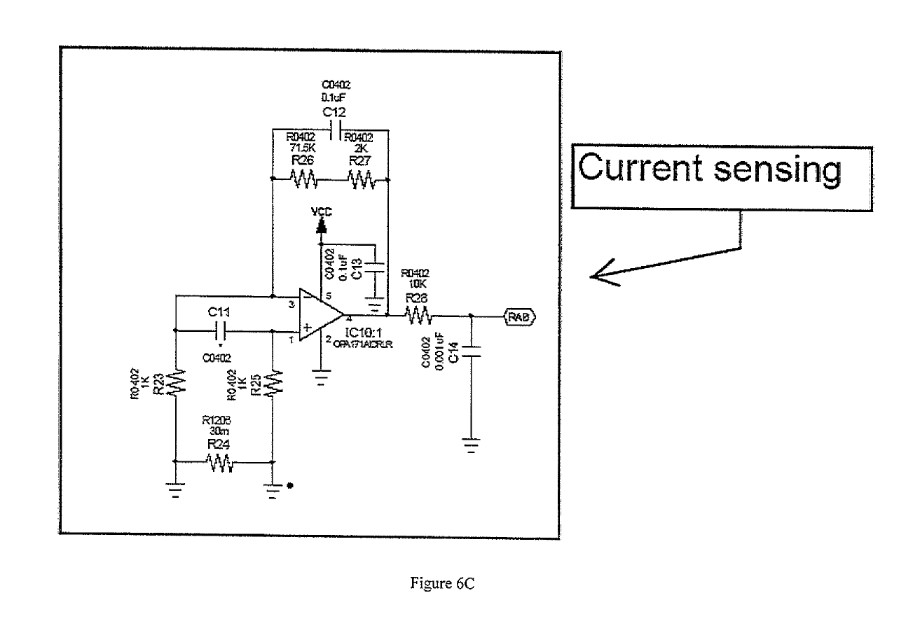

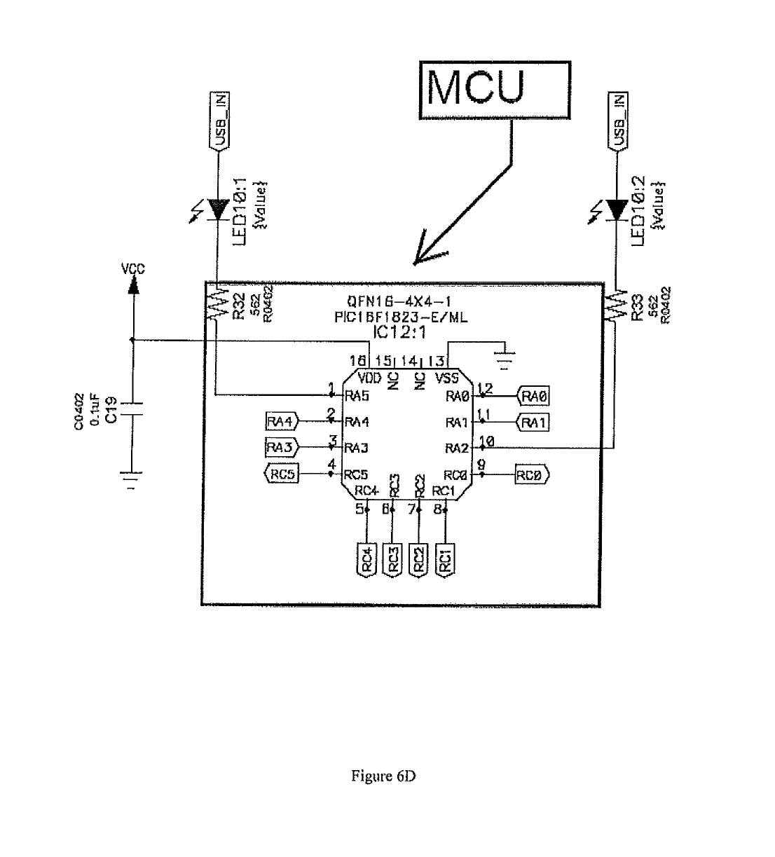

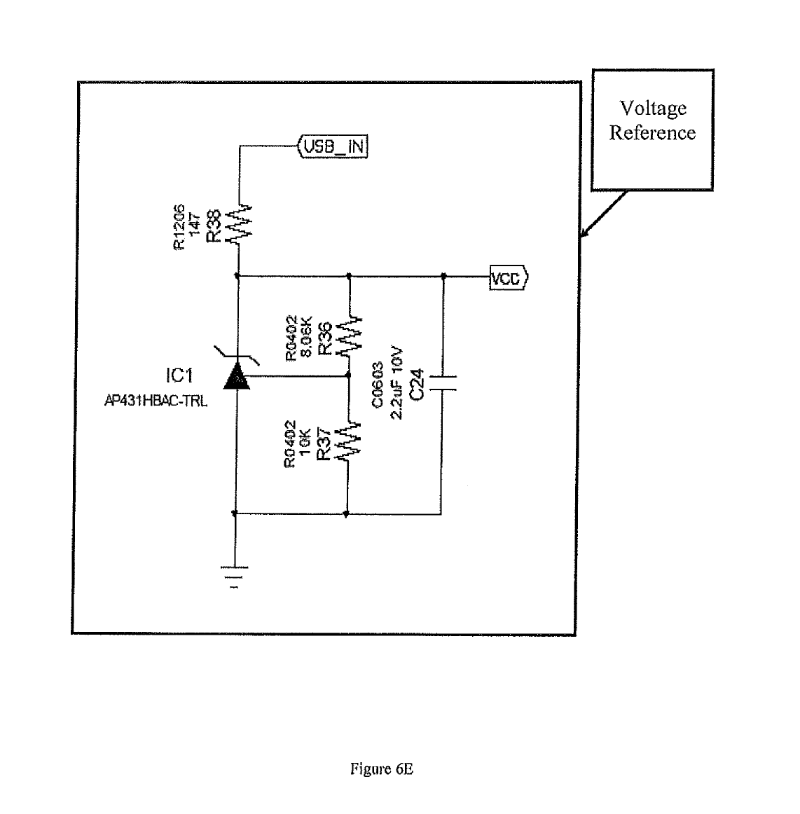

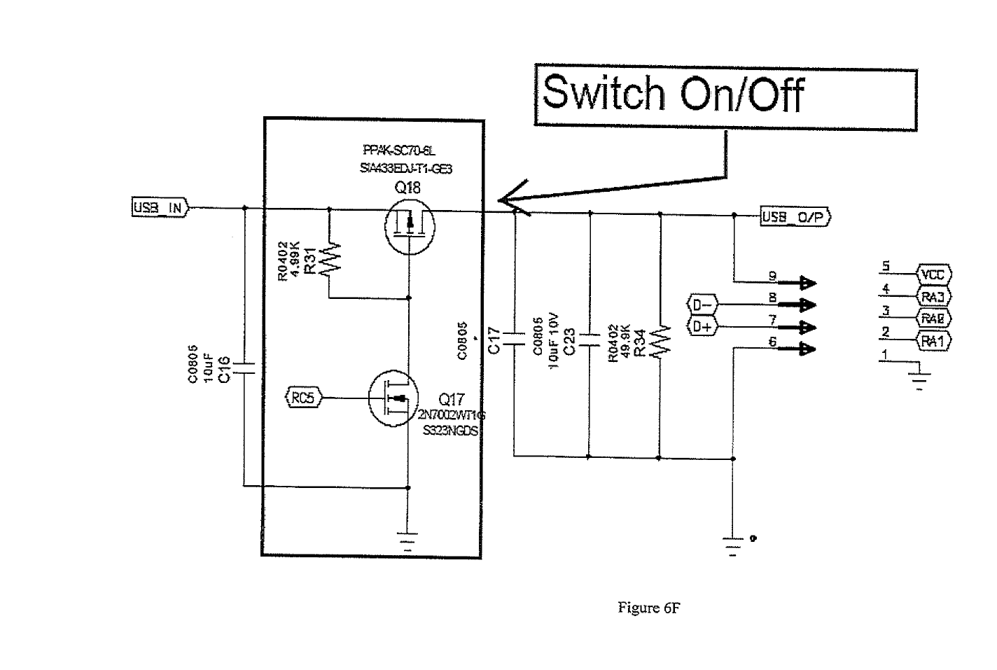

As seen from the figures, the Automatic protocol (AP) is the data lines manager that enables any portable device to recognize and understand its connection to its USB charger. The AP of the present invention can modify the voltage at the data lines of the USB port to meet the voltage needs of most portable devices, by automatically changing voltage pin2(D−) and pin3(D+) when using this AP with the new portable devices. The AP comprises an analog switch, resistors network, current sensing, power on/off switch and microcontroller unit (MCU) with flash memory inside (FIG. 2). The resister network is controlled by analog switch to switch each connection become difference impedance and having difference voltage level since the resistor connect between the USB Vbus and ground and the analog switch is controlled by microcontroller for setting the data lines which a portable device needs for charging its battery in charging mode (FIGS. 2, 3, 6D). The current sensing (FIGS. 4, 6C) detects the charging current and tells the microcontroller unit to recognize that a portable device needs to allow the USB charger to charge its battery. The power switch (FIGS. 2, 6F) provides the charging voltage and current to the portable device when it is turned on. The microcontroller unit will control the analog switch to change resistor network and monitors every behavior while the portable device is plugged in or plugged out with the AP as the data lines and the charging current then makes the decision as to the voltage needs of the portable device that the AP connects with.

The objective of the invention is to provide an application that able automatic change voltage configuration on pin2 (D−) and pin3 (D+) for most portable devices in order to get charging mode. The way the invention is implemented, according to the figures, and according to the principles of the present invention, is by using the MCU (microcontroller unit) to control the analog switch to switch the resistor connection from USB output and ground. The resistors are designed to provide specified value matching that MCU can control to get the right voltage D− and D+ value for most portable devices currently on the market. The On/Off output switches are used for resetting the mobile (portable) device every time there is a change in the resistor network configuration. The MCU is programmed in order to control all analog switches to switch resistor network accordingly to MCU program.

### Description of AP Functions

The automatic protocol application comprises MCU (Micro controller unit), analog switch, resistor network, current sensing and output On/Off switch. These components are shown in the figures, and described further below.

MCU (microcontroller unit): The MCU is designed to check signal from the device (e.g. a portable device), via USB port data line D− and D+, and when appropriate provides different voltage level on pin 2(D−) and pin 3(D+) condition to the portable device (FIG. 2). After that the MCU will keep checking the device to understand if the device got the right voltage on pin2 and pin3 and allows the charger circuit to charge the portable device. The MCU purpose is to check all portable device signals and control the analog switch to change resistor network following MCU program change difference voltage level on pin2(D−) and pin3(D+).

The MCU is capable of being upgraded (e.g. in its firmware) when new portable devices are released to the marketplace.

Analog Switches (FIG. 6A):

The circuit components shown in FIGS. 6A-6F show one example of the manner in which the principles of the present invention can be implemented. Thus, FIG. 6A shows a circuit component for controlling several analog switches that are used for switching and changing resistors of the resistors network connection to get difference voltage on pin D− and D+ of USB port. FIG. 3 illustrates that concept in connection with analog switches SW1, SW2, SW3, SW4, SW5, SW6 and SW7. All analog switches SW are controlled by MCU (FIGS. 2, 3). It will be clear to those in the art that while FIGS. 6A-6F show one example of the implementation of the present invention, the principles of the present invention can be implemented in various ways, to provide the types of functions described in this application.

Resistor Network (FIGS. 3, 6B):

In the example of FIGS. 6A-6F, the resistor network uses resistors R1, R2, R3, R4, R5, R6 and R7 as shown in FIG. 3 that are connected to each analog switch to form the resistor network. The purpose of the resistor network is to change connection of each switch when the MCU provides difference voltage on pin D− and D+ and sends the difference voltage to the portable device being charged.

Current Sense (FIG. 4):

In the example of FIGS. 6A-6F, an Op-amp amplify signal across resistor is designed to sense and send signal to MCU. It is illustrated in FIG. 4. The purpose of the current sense is to keep checking current from the portable device when the portable device gets the right voltage and allow charger to provide the charge. The current sense circuit will send a signal to MCU that the portable device is in condition to allow the charger to charge the device.

Output On/Off Switch (FIGS. 2, 6F):

In the example of FIGS. 6A-6F, the output on/off switch's purpose is to reset and turn off the charger every time the resistor networks change voltage level. Most portable devices are always checking voltage pin2 (D−) and pin3 (D+) the first time the charger is plugged to a portable device and if the voltage is consistent and at a level that the portable device needs then the portable device will recognize and authorize charger to charge the device.

In order to sequence which protocol standard the device to be charged has, the present invention provides a mechanism to start from scratch (reset the whole procedure). The power on/off switch serves this purpose. If a resistor network protocol is the incorrect one, the device to be charged might not “listen” to any other changes in the D+ and D− signals after the initial power on. So the charging device would have to disconnect power for a time and retry a different protocol. Each protocol is tried in sequence from the most popular to the least. Each time a new protocol is tried the USB 5V output is turned off to reset the startup sequence. For the charger to know when the right protocol is reached the current sensor monitors the amount of current the device to be charged is allowing to flow. When a significant increase over the 100 mA standard is reached then the assumption by the microcontroller is that the right protocol was found and locked in for this charging session and no more searching has to be done.

Voltage Reference (FIG. 6E).

In the example of FIGS. 6A-6F, a voltage reference function is provided as part of the microcontroller, and FIG. 6E shows an example of how that function can be implemented. The voltage reference provides a common voltage reference (or bias) against which the microcontroller can make a comparison when it gets input from the current sensing component that monitors the amount of current the device to be charged is allowing to flow.

### Further Comments:

As will be clear to those in the art from the foregoing detailed description, the present invention relates to a new and useful automatic protocol (AP) for a USB charger, which comprises a circuit that enables recognition of the voltage pin2 (D−) and pin3 (D+) needs of the device being charged, and controls the voltage level to charge the device, based on the recognized voltage needs. In a preferred embodiment, described herein, the circuit is configured to charge any of a plurality of different portable devices, each of which has different voltage needs. The circuit is configured to modify the voltage at the data lines of a USB port to meet needs of any of the plurality of portable devices. Also, the circuit (FIG. 2) includes a USB charger that comprises one or more analog switches, a resistors network, a current sensing device, a power on/off switch and a microcontroller unit (MCU), preferably with flash memory inside. The circuit is characterized by the following features:
a. The resister network (FIGS. 2, 3, 6B) is controlled by the analog switches (FIGS. 3, 6A) to control impedance and voltage levels at the USB port while the resistor network is connected between the USB Vbus and ground, and the analog switches are controlled by the microcontroller (FIGS. 2, 3, 6D) for setting the data lines which a portable device needs for charging its battery in a charging mode.
b. The current sensing device (FIGS. 2, 4, 6C) detects the charging current and tells the microcontroller unit to recognize that a portable device needs to allow the USB charger to charge its battery, and the power on/off switch (FIGS. 2, 6F) provides the charging voltage and current to the portable device when it is turned on.
c. the power on/off switch (FIGS. 2, 5, 6F) is controlled by the microcontroller when there is a need to reset the USB charger circuit, and the current sensing device (FIGS. 2, 6C) detects the charging current and communicates with the microcontroller to enable the microcontroller unit to recognize whether the USB charger circuit is properly set for charging the device being charged.
d. In order to sequence which protocol standard the device to be charged has, the present invention provides a mechanism to start from scratch (reset the whole procedure). The power on/off switch serves this purpose. If a resistor network protocol is the incorrect one, the device to be charged might not “listen” to any other changes in the D+ and D− signals after the initial power on. So the charging device would have to disconnect power for a tune and retry a different protocol. Each protocol is tried in sequence from the most popular to the least. Each time a new protocol is tried the USB 5V output is turned off to reset the startup sequence. For the charger to know when the right protocol is reached the current sensor monitors the amount of current the device to be charged is allowing to flow. When a significant increase over the 100 mA standard is readied then the assumption by the microcontroller is that the right protocol was found and locked in for this charging session and no more searching has to be done.
e. The microcontroller controls the analog switches (FIGS. 2, 3, 6D) to charge the state of the resistor network and monitors behavior of the automatic protocol while the portable device is plugged in or plugged out of the USB charger as the data lines and the charging current communicates with the microprocessor (FIG. 2) which makes the decision as to the voltage needs of the portable device that the USB charger connects with.
f. The microcontroller controls the analog switches (FIGS. 2, 3, 6D) to switch the resistor network connection from USB output and ground, and the resistor network is configured to provide specified value matching that the microcontroller can control to get the right voltage D− and D+ value for any of the plurality of portable devices, where the On/Off output switches (FIGS. 2, 6F) are configured to reset the USB charger circuit when there is a change in the portable device that requires a change in the resistor network configuration, and the microcontroller is configured to control all analog switches to switch resistor network accordingly.
g. The microcontroller is configured to check signal from a portable device connected to the USB charger, via USB port data line D− and D+, and to provide difference voltage level on pin 2(D−) and pin 3(D+) condition to the portable device, and thereafter to keep checking the portable device and the current sensing to understand if the portable device got the right voltage on pin2 and pin3. (FIG. 2).
h. The microcontroller (FIGS. 2, 3, 6D) is configured to check all portable device signals and control the analog switch(es) to change resistor network following any microcontroller change of the voltage level on pin2(D−) and pin3(D+).
i. The analog switches (FIGS. 3, 6D) are configured to switch and change resistor of all resistors network connection to get difference voltage on pin D− and D+ of USB port.
j. The resistor network (FIG. 6B) comprises a plurality of resisters in a predetermined configuration, and connected to each analog switch to form the resistor network in a manner such that the resistor network changes connection of each analog switch when the microcontroller provides difference voltage on pin D− and D+ and sends the difference voltage to the portable device being charged (FIGS. 2, 3 6D).
k. The current sense (FIG. 4) comprises Op-amp amplify signal across the resistor network that is designed to sense and send signal to the microcontroller, to keep checking current from the portable device to enable the microcontroller to determine when the portable device gets the right voltage and to send a signal to the microcontroller that the portable device is in condition to allow the charger to charge the device.
l. The Output On/Off switch (FIGS. 2, 6F) is configured to turn off and reset the USB charger every time the resistor networks change voltage level, so that if the voltage is consistent and at a level that the portable device needs then the microcontroller will recognize and authorize the USB charger to charge the portable device.

Thus, As described above, a new and useful automatic protocol (AP) for a USB charger is provided, which comprises a circuit that enables recognition of the voltage pin2 (D−) and pin3 (D+) needs of the device being charged, and controls the voltage level to charge the device, based on the recognized voltage needs. From that description the manner in which the principles of the present invention can be applied to various USB charger circuits will be apparent to those in the art.

1. An automatic protocol (AP) for a USB charger comprises a circuit that enables recognition of the voltage pin (D−) and pin (D+) needs of the device being charged, and controls the voltage level to charge the device, based on the recognized voltage needs.

2. The automatic protocol for a USB charger of claim 1, where the circuit is configured to charge any of a plurality of different portable devices, each of which has different voltage needs.

3. The automatic protocol for a USB charger of claim 2, where the circuit is configured to modify the voltage at the data lines of a USB port to meet needs of any of the plurality of portable devices.

4. The automatic protocol for a USB charger of claim 1, where the circuit includes a USB charger that comprises one or more analog switches, a resistors network, a current sensing device, a power on/off switch and a microcontroller unit (MCU); where the resister network is controlled by the analog switches to control impedance and voltage levels at the USB port while the resistor network is connected between the USB Vbus and ground, and the analog switches are controlled by the microcontroller for setting the data lines which a portable device needs for charging its battery in a charging mode.

5. The automatic protocol for a USB charger of claim 4, wherein the power on/off switch is controlled by the microcontroller when there is a need to reset the USB charger circuit, and wherein the current sensing device detects the charging current and communicates with the microcontroller to enable the microcontroller unit to recognize whether the USB charger circuit is properly set for charging the device being charged.

6. The automatic protocol for a USB charger of claim 5, wherein the microcontroller controls the analog switches to change the state of the resistor network and monitors behavior of the automatic protocol while the portable device is plugged in or plugged out of the USB charger as the data lines and the charging current communicates with the microprocessor which makes the decision as to the voltage needs of the portable device that the USB charger connects with.

7. The automatic protocol for a USB charger of claim 6 wherein the microcontroller controls the analog switches to switch the resistor network connection from USB output and ground, and the resistor network is configured to provide specified value matching that the microcontroller can control to get the right voltage D− and D+ value for any of the plurality of portable devices, where the On/Off output switches are configured to reset the USB charger circuit when there is a change in the portable device that requires a change in the resistor network configuration, and the microcontroller is configured to control all analog switches to switch resistor network accordingly.

8. The automatic protocol for a USB charger of claim 7, wherein the microcontroller is configured to check signal from a portable device connected to the USB charger, via USB port data line D− and D+, and to provide difference voltage level on pin 2(D−) and pin 3(D+) condition to the portable device, and thereafter to keep checking the portable device and the current sensing to understand if the portable device got the right voltage on pin2 and pin3.

9. The automatic protocol for a USB charger of claim 7, wherein the resistor network comprises a plurality of resisters in a predetermined configuration, and connected to each analog switch to form the resistor network in a manner such that the resistor network changes connection of each analog switch when the microcontroller provides difference voltage on pin D− and D+ and sends the difference voltage to the portable device being charged.

10. The automatic protocol for a USB charger of claim 7, wherein the current sense comprises an Op-amp amplify signal across the resistor network that is designed to sense and send signal to the microcontroller, to keep checking current from the portable device to enable the microcontroller to determine when the portable device gets the right voltage and to send a signal to the microcontroller that the portable device is in condition to allow the charger to charge the device.

11. The automatic protocol for a USB charger of claim 7, wherein the Output On/Off switch is configured to turn off and reset the USB charger every time the resistor networks change voltage level, so that if the voltage is consistent and at a level that the portable device needs then the microcontroller will recognize and authorize the USB charger to charge the portable device.
